(19) United States
(12) Patent Application Publication
(10) Pub. No.: US 2013/0236637 A1
(43) Pub. Date: Sep. 12, 2013

(54) PROCESS FOR MANUFACTURING COPPER HYDRIDE FINE PARTICLE DISPERSION, ELECTROCONDUCTIVE INK, AND PROCESS FOR MANUFACTURING SUBSTRATE EQUIPPED WITH CONDUCTOR

(71) Applicant: ASAHI GLASS COMPANY, LIMITED, Tokyo (JP)

(72) Inventors: Satoshi KASHIWABARA, Tokyo (JP); Hideyuki HIRAKOSO, Tokyo (JP); Takashige YONEDA, Tokyo (JP)

(73) Assignee: ASAHI GLASS COMPANY, LIMITED, Tokyo (JP)

(21) Appl. No.: 13/867,732

(22) Filed: Apr. 22, 2013

Related U.S. Application Data
(63) Continuation-in-part of application No. PCT/JP2011/073741, filed on Oct. 14, 2011.

(30) Foreign Application Priority Data
Oct. 21, 2010 (JP) 2010-236497

(51) Int. Cl. C01B 6/02

(52) U.S. Cl. CPC C01B 6/02
USPC 427/98.4; 423/645

(57) ABSTRACT

The present invention relates to a process for manufacturing a copper hydride fine particle dispersion, the process including: reducing a copper(II) salt with a hydrido-based reducing agent in the following solvent (A) in the presence of the following alkylamine (B): solvent (A): a solvent having a solubility parameter (SP value) of from 8 to 12 and being inert to the hydrido-based reducing agent and alkylamine (B): an alkylamine having an alkyl group which has 7 or more carbon atoms and having a boiling point of 250° C. or lower.

### TECHNICAL FIELD

The present invention relates to a process for manufacturing a copper hydride fine particle dispersion, a conductive ink, and a process for manufacturing a substrate equipped with conductor.

### BACKGROUND OF THE INVENTION

For example, as a process for manufacturing a substrate equipped with a conductor having a circuit pattern such as a printed wiring, there is known a method of printing an conductive ink composed of a dispersion containing a fine particle of a metal such as silver or copper dispersed therein on a substrate by an inkjet printing method and baking the ink to form a conductor. As the metal fine particle, in view of costs, a copper fine particle is advantageous than a silver fine particle. However, since the copper fine particle is easily oxidized, there is a problem that volume resistivity of the conductor increases and conductivity decreases.

In order to suppress the increase in volume resistivity of the conductor, there is disclosed a copper hydride fine particle dispersion containing copper hydride fine particles which are difficult to be oxidized in the air and are dispersed therein (Patent Document 1). As a process for manufacturing the copper hydride fine particle dispersion, there is disclosed a method of adding an alkylamine such as dodecylamine and a non-water soluble organic liquid to an aqueous solution of pH 3 or lower containing a copper(II) ion, reducing the copper(II) ion with NaBH₄ or the like, and subsequently separating the organic phase. In the method, fine particles of copper hydride formed by the reduction of the copper(II) ion in the aqueous phase is incorporated into the organic phase through coordination of the alkylamine on the surface of the particles. Thereby, it is suppressed to change the formed copper hydride into a copper(II) ion and copper(II) oxide in water.

At the time of manufacturing a substrate equipped with a conductor using the obtained copper hydride fine particle dispersion, baking is performed after applying the dispersion on the substrate. Thereby, the copper hydride in the copper hydride fine particle is converted into metal copper, further the alkylamine on the fine particle surface is eliminated, and the metal copper fine particles are melted and combined one another, thereby forming the conductor.

### BACKGROUND ART

### Patent Document

[Patent Document 1] WO04/110925 pamphlet

### SUMMARY OF THE INVENTION

### Problems that the Invention is to Solve

In the process for manufacturing a copper hydride fine particle dispersion described in Patent Document 1, at the time of forming a conductor using the obtained copper hydride fine particle dispersion, it is required to perform baking at a temperature exceeding 150° C. (for example, around 350° C.). When baking temperature is high, the baking cannot be applied to a substrate of a material such as polyethylene terephthalate (PET) or polyethylene naphthalate (PEN) from the standpoint of thermal degradation of the substrate itself.

An object of the present invention is to provide a process for manufacturing a copper hydride fine particle dispersion capable of forming a conductor having a small volume resistivity even onto a substrate of PET, PEN, or the like. Moreover, an object of the invention is to provide a conductive ink using the copper hydride fine particle dispersion obtained by the above manufacturing process, and a process for manufacturing a substrate equipped with a conductor using the conductive ink.

### Means for Solving the Problems

In the invention, in order to solve the above problems, the following constitutions are adopted.

[1] A process for manufacturing a copper hydride fine particle dispersion, the process comprising: reducing a copper(II) salt with a hydrido-based reducing agent in the following solvent (A) in the presence of the following alkylamine (B): solvent (A): a solvent having a solubility parameter (SP value) of from 8 to 12 and being inert to the hydrido-based reducing agent and alkylamine (B): an alkylamine having an alkyl group which has 7 or more carbon atoms and having a boiling point of 250° C. or lower.

[2] The process for manufacturing a copper hydride fine particle dispersion according to [1], wherein the copper(II) salt is at least one selected from the group consisting of copper(II) acetate, copper(II) formate, copper(II) nitrate, and copper(II) carbonate.

[3] The process for manufacturing a copper hydride fine particle dispersion according to [1] or [2], wherein a molar ratio (Cu/B) of the copper(II) salt to the alkylamine (B) is 1.8 or lower.

[4] The process for manufacturing a copper hydride fine particle dispersion according to any one of [1] to [3], wherein the alkylamine (B) is at least one selected from the group consisting of n-heptylamine, n-octylamine, n-nonylamine, 1-aminodecane, and 1-aminoundecane.

[5] The process for manufacturing a copper hydride fine particle dispersion according to any one of [1] to [4], wherein a copper hydride fine particle dispersion containing copper hydride fine particles having an average primary particle diameter of 100 nm or lower dispersed therein is obtained.

[6] A conductive ink manufactured using the copper hydride fine particle dispersion manufactured by the process for manufacturing a copper hydride fine particle dispersion according to any one of [1] to [5].

[7] A process for manufacturing a substrate equipped with a conductor, the process comprising: applying the conductive ink according to [6] on the substrate, followed by heating the conductive ink to form the conductor.

### Advantage of the Invention

According to the process for manufacturing a copper hydride fine particle dispersion of the present invention, a copper hydride fine particle dispersion is capable of forming a conductor having a small volume resistivity even onto a substrate of PET, PEN, or the like.

Moreover, the conductive ink of the invention can form a conductor having a small volume resistivity even onto a substrate of PET, PEN, or the like.

In addition, according to the process for manufacturing a substrate equipped with a conductor of the invention, a substrate equipped with a conductor having a small volume resistivity is obtained even on a substrate of PET, PEN, or the like.

### MODE FOR CARRYING OUT THE INVENTION

### Process for Manufacturing Copper Hydride Fine Particle Dispersion

The process for manufacturing a copper hydride fine particle dispersion of the invention is a process of reducing a copper(II) salt with a hydrido-based reducing agent in the presence of an alkylamine (B) to be mentioned later in a solvent (A) to be mentioned later.

As the copper(II) salt, a salt capable of forming a copper(II)-amine complex with the alkylamine (B) may be used. The copper(II) salt may be an anhydride or a hydrate.

The copper(II) salt is represented by CuX₂ or CuY, wherein X is a monovalent base and Y is a divalent base. At the time when the copper(II) salt is reduced with the hydrido-based reducing agent to form copper hydride fine particles, it is considered that X contained in the copper(II) salt is liberated as HX and Y is liberated as H₂Y. In the invention, a salt which liberates HX or H₂Y (hereinafter also referred to as free acid) whose boiling point or decomposition point is 150° C. or lower is preferred. This is because the free acid is easily vaporized upon heating at the time of conductor formation and a conductor having a low volume resistivity is easily formed.

Examples of the copper(II) salt include copper(II) oxalate (decomposition point of oxalic acid to be liberated: 189.5° C.), copper(II) chloride (boiling point of hydrochloric acid to be liberated: 110° C.), copper(II) acetate (boiling point of acetic acid to be liberated: 118° C.), copper(II) formate (boiling point of formic acid to be liberated: 100.75° C.), copper(II) nitrate (boiling point of nitric acid to be liberated: 82.6° C.), copper(II) sulfate (boiling point of sulfuric acid to be liberated: 290° C.), copper(II) tartrate (boiling point and decomposition point of tartaric acid to be liberated: unknown), copper(II) citrate (decomposition point of citric acid to be liberated: 175° C.), copper(II) carbonate (boiling point and decomposition point of carbonic acid to be liberated: unknown), and copper(II) oleate (boiling point of oleic acid to be liberated: 193° C./100 Pa, decomposition point thereof: 400° C. or higher). Of these, copper(II) acetate, copper(II) formate, copper(II) nitrate, and copper(II) carbonate are preferred.

One kind of the copper(II) salt may be used singly or two or more thereof may be used in combination.

Examples of the hydrido-based reducing agent include NaBH₄, LiBH₄, Zn(BH₄)₂, (CH₃)₄NBH(OCOCH₃)₃, NaBH₃CN, LiAlH₄, (i-Bu)₂AlH (DIBAL), LiAlH(t-BuO)₃ and NaAlH₂(OCH₂CH₂OCH₃)₂ (Red-Al). Of these, from the standpoint of easiness of controlling the reduction rate that is important for regulation of the particle diameter of the copper hydride fine particles, at least one selected from the group consisting of NaBH₄, LiBH₄, and NaBH₃CN is preferred.

One kind of the hydrido-based reducing agent may be used singly or two or more thereof may be used in combination.

The solvent (A) is a solvent that has a solubility parameter (SP value) of from 8 to 12. When the SP value is from 8 to 12, compatibility of the solvent (A) with water is low and thus incorporation of water into the reaction system can be suppressed. Thereby, deactivation of the hydrido-based reducing agent dissolved in the solvent (A) through the reaction with water can be suppressed.

It is more preferable that the solvent (A) has the SP value of from 8.5 to 9.5.

Examples of the solvent (A) include cyclohexane (SP value: 8.2), isobutyl acetate (SP value: 8.3), isopropyl acetate (SP value: 8.4), butyl acetate (SP value: 8.5), carbon tetrachloride (SP value: 8.6), ethylbenzene (SP value: 8.8), xylene (SP value: 8.8), toluene (SP value: 8.9), ethyl acetate (SP value: 9.1), tetrahydrofuran (SP value: 9.1), benzene (SP value: 9.2), chloroform (SP value: 9.3), methylene chloride (SP value: 9.7), carbon disulfide (SP value: 10.0), acetic acid (SP value: 10.1), pyridine (SP value: 10.7) and dimethylformamide (SP value: 12.0).

Moreover, as the solvent (A), a solvent inert to the hydrido-based reducing agent to be used in the reduction reaction is employed. Namely, by using a solvent that is not reduced by the hydrido-based reducing agent to be used in the reduction reaction or a solvent having no active hydrogen as the solvent (A), the deactivation with the hydrido-based reducing agent can be suppressed.

As the solvent (A), from the standpoint of easiness of regulation of the reduction reaction and from the standpoint of dispersibility of the copper hydride fine particles to be formed, hydrocarbons such as toluene, xylene, and benzene; ethers such as tetrahydrofuran; and esters such as ethyl acetate, isopropyl acetate, and isobutyl acetate; are preferred and toluene and xylene are particularly preferred.

One kind of the solvent (A) may be used singly or two or more thereof may be used in combination.

Furthermore, the hydrido-based reducing agent has different reducing power depending on the kind. For example, NaBH₄ does not reduce esters but LiAlH₄ reduces esters. Accordingly, depending on the kind of the hydrido-based reducing agent to be used, an appropriate solvent is selected from the solvents described as the solvent (A) and used.

The alkylamine (B) is an alkylamine that has an alkyl group having 7 or more carbon atoms and has a boiling point of 250° C. or lower.

When the carbon number of the alkyl group in the alkylamine (B) is 7 or more, the dispersibility of the copper hydride fine particles to be formed becomes good. In the invention, since the reaction field is an organic phase, it is not necessary to use an alkylamine having a large carbon number for the purpose of protection from water. The carbon number of the alkyl group in the alkylamine (B) is preferably 11 or less from the standpoint of suppressing the boiling point to be excessively high.

When the boiling point of the alkylamine (B) is 250° C. or lower, at the time of the conductor formation, the alkylamine (B) can be eliminated from the fine particle surface and vaporized even upon heating at 150° C. or lower to form a conductor having a low volume resistivity. The boiling point of the alkylamine (B) is preferably 250° C. or lower and more preferably 200° C. or lower in view of elimination ability and volatility upon heating. Also, the boiling point of the alkylamine (B) is usually preferably 150° C. or higher in view of regulating the carbon number of the alkyl group to 7 or more.

The alkyl group of the alkylamine (B) is preferably a linear alkyl group from the standpoint of dispersion stability of the copper hydride fine particles to be obtained. However, the alkyl group of the alkylamine (B) may be a branched alkyl group.

As the alkylamine (B), n-heptylamine (carbon number of alkyl group: 7, boiling point: 157° C.), n-octylamine (carbon number of alkyl group: 8, boiling point: 176° C.), n-nonylamine (carbon number of alkyl group: 9, boiling point: 201° C.), 1-aminodecane (carbon number of alkyl group: 10, boiling point: 220° C.), 1-aminoundecane (carbon number of alkyl group: 11, boiling point: 242° C.) are preferred, and n-heptylamine and n-octylamine are more preferred.

One kind of the alkylamine (B) may be used singly or two or more thereof may be used in combination.

In the process for manufacturing a copper hydride of the invention, the copper hydride fine particles are formed by reducing the copper(II) salt with the hydrido-based reducing agent in the presence of the alkylamine (B). In the presence of the alkylamine (B), the alkylamine (B) coordinates to copper(II) to form a copper(II)-amine complex and subsequently the copper(II)-amine complex is reduced with the hydrido-based reducing agent. Thereby, formation of clumps of copper hydride owing to rapid reduction of the copper(II) salt can be suppressed and copper hydride fine particles where the alkylamine (B) is coordinated to the surface of the fine particles of copper hydride are formed.

In addition, in the manufacturing process of the invention, since the solubility of the hydrido-based reducing agent in the solvent (A) is not so high, most of the agent is present in a solid form in the solvent (A) and a part thereof is dissolved in the solvent (A). When the hydrido-based reducing agent dissolved in the solvent (A) reduces the cooper(II) salt and is consumed, the hydrido-based reducing agent present in the solid form is gradually dissolved into the solvent (A). Thus, the hydrido-based reducing agent gradually dissolved into the solvent (A) sequentially contributes to the reduction reaction, so that the reduction reaction does not rapidly proceed and the copper hydride fine particles are stably formed.

The formed copper hydride fine particles can be dispersed in the solvent (A) since the alkylamine (B) coordinates to the surface.

The order of adding the copper(II) salt, the hydrido-based reducing agent, and the alkylamine (B) to the solvent (A) is preferably an order of the alkylamine (B), the copper(II) salt, and the hydrido-based reducing agent. Thereby, after the copper(II)-amine complex is formed, the reduction of the copper(II)-amine complex with the hydrido-based reducing agent easily proceeds and the copper hydride fine particles are more stably obtained.

However, the order of adding the copper(II) salt, the hydrido-based reducing agent, and the alkylamine (B) to the solvent (A) is not limited to the above order as long as it is an order where the reduction reaction with the hydrido-based reducing agent proceeds in the presence of the alkylamine (B). For example, the alkylamine (B), the hydrido-based reducing agent, and the copper(II) salt may be added to the solvent (A) in this order. In this case, the hydrido-based reducing agent is present in a solid form in the solvent (A) and, after the copper(II)-amine complex is formed in the solvent (A), the copper(II)-amine complex present in the solid form reacts with the hydrido-based reducing agent. Furthermore, it is permissible to add the hydrido-based reducing agent, the alkylamine (B), and the copper(II) salt in this order.

The reduction reaction with the hydrido-based reducing agent may be carried out with stirring the solvent (A). Thereby, the reduction reaction proceeds more easily.

The reaction temperature is preferably from 0 to 80° C. and more preferably from 15 to 50° C. When the reaction temperature is the lower limit of the range or higher, the reduction reaction easily proceeds. When the reaction temperature is the upper limit of the range or lower, the dispersibility of the copper hydride fine particles in the copper hydride fine particle dispersion to be obtained is good and, as a result, a conductor having a small volume resistivity is formed more easily.

The amount of the copper(II) salt to be added is preferably 0.1×10⁻³ mol or more, more preferably 0.15×10⁻³ mol or more, and particularly preferably 0.25×10⁻³ mol or more per 1 g of the solvent (A) from the standpoint of productivity of the copper hydride fine particles. Also, the amount of the copper(II) salt to be added is preferably 0.65×10⁻³ mol or less, more preferably 0.6×10⁻³ mol or less, and particularly preferably 0.5×10⁻³ mol or less per 1 g of the solvent (A) from the standpoint of easiness of regulation of the reduction reaction.

The amount of the alkylamine (B) to be added is preferably 0.2×10⁻³ mol or more, more preferably 0.25×10⁻³ mol or more, and particularly preferably 0.3×10⁻³ mol or more per 1 g of the solvent (A) from the standpoint of good dispersibility of the copper hydride fine particles in the copper hydride fine particle dispersion to be obtained. Also, when the amount of the alkylamine (B) to be added is excessive, there is a concern that the alkylamine (B) which does not coordinate to the copper(II) salt remains at the conductor formation and increases the volume resistivity of the conductor. Accordingly, the upper limit of the amount of the alkylamine (B) is preferably 0.75×10⁻³ mol or less, more preferably 0.7×10⁻³ mol or less, and particularly preferably 0.6×10⁻³ mol or less per 1 g of the solvent (A).

The amount of the hydrido-based reducing agent to be added is preferably 0.25×10⁻³ mol or more, more preferably 0.3×10⁻³ mol or more, and particularly preferably 0.35×10⁻³ mol or more per 1 g of the solvent (A) from the standpoint of yield of the copper hydride fine particles. Also, the amount of the hydrido-based reducing agent to be added is preferably 0.65×10⁻³ mol or less, more preferably 0.55×10⁻³ mol or less, and particularly preferably 0.5×10⁻³ mol or less per 1 g of the solvent (A) from the standpoint of easiness of regulation of the reduction reaction.

The molar ratio (Cu/B) of the copper(II) salt (Cu) to the alkylamine (B) to be added into the solvent (A) is preferably 1.8 or less, more preferably 1.4 or less, and particularly preferably 1.2 or less from the stand point that the dispersion stability of the copper hydride fine particles to be formed becomes good. Also, the molar ratio (Cu/B) is preferably 0.64 or more and more preferably 0.85 or more in view of easiness of elimination and vaporization of the alkylamine (B) from the fine particle surface upon heating at the conductor formation.

The molar ratio (Cu/R) of the copper(II) salt (Cu) to the hydrido-based reducing agent (R) to be added to the solvent (A) is preferably 1.42 or less, more preferably 1.3 or less, and particularly preferably 1.2 or less from the stand point that the reduction reaction is prone to proceed sufficiently. Also, the molar ratio (Cu/R) is preferably 0.7 or more, more preferably 0.8 or more, and particularly preferably 0.9 or more in view of easiness of regulating the reduction reaction.

The average primary particle diameter of the copper hydride fine particles (primary particles) to be formed is preferably 100 nm or less, more preferably from 5 to 70 nm, and particularly from 5 to 35 nm. When the average primary particle diameter of the copper hydride fine particles is the upper limit of the above range or less, sinterability at low temperature which is a characteristic feature of fine particles becomes good and it becomes possible to reduce the volume resistivity of the conductor to be obtained. Also, when the average primary particle diameter of the copper hydride fine particles is the lower limit of the above range or more, the copper hydride fine particles can be stably dispersed. In the present specification, a minimum unit of dispersed particles is taken as the primary particle diameter. Moreover, in the case of particles in an aggregated form, individual particles constituting the aggregate are taken as primary particles.

The average primary particle diameter of the copper hydride fine particles can be controlled by the amount of the alkylamine (B) to be added and the amount of the hydrido-based reducing agent to be added. When the amount of the alkylamine (B) to be added increases, the average primary particle diameter of the copper hydride fine particles tends to decrease. Also, when the amount of the hydrido-based reducing agent to be added decreases, the average primary particle diameter of the copper hydride fine particles tends to decrease.

In this regard, the average primary particle diameter of the copper hydride fine particles is a value determined by measuring the particle diameter of randomly sampled 100 fine particles using a transmission electron microscope or a scanning electron microscope and averaging the resulting values thereof.

The solid mass concentration of the copper hydride fine particle dispersion (100% by mass) is preferably from 1 to 6% by mass and more preferably from 2.5 to 4.5% by mass. When the solid mass concentration of the copper hydride fine particle dispersion is less than the lower limit of the above range, there is a concern that the concentration step takes a lot of time and thus productivity decreases. When the solid mass concentration of the copper hydride fine particle dispersion exceeds the upper limit of the above range, there is a concern that the dispersion stability of the copper hydride fine particles in the copper hydride fine particle dispersion is deteriorated.

The copper hydride fine particles in the invention eliminate the alkylamine (B) upon heating. Also, the copper hydride changes into metal copper, for example, by heating at 60° C. or higher. Therefore, a conductor can be formed by heating the copper hydride fine particles in the invention to eliminate the alkylamine (B) on the particle surface and change the copper hydride into metal copper and melting and combining the formed metal copper fine particles.

According to the process for manufacturing a copper hydride fine particle dispersion of the invention as described above, there is obtained a copper hydride fine particle dispersion in which copper hydride fine particles capable of forming a conductor having a small volume resistivity are dispersed. This is because copper hydride is less prone to be oxidized as compared with metal copper and thus the oxidation of the copper hydride fine particles formed by the manufacturing process of the invention during storage, heating, and the like in the air is suppressed.

Moreover, according to the process for manufacturing a copper hydride fine particle dispersion of the invention, there is obtained a copper hydride fine particle dispersion in which copper hydride fine particles capable of forming a conductor even upon heating at 150° C. or lower are dispersed. This is because the metal copper fine particles changed from the copper hydride fine particles are melted and combined even at lower temperature (around from 100 to 120° C.) owing to a surface melting phenomenon of particles and also, in the manufacturing process of the invention, the alkylamine (B) having a boiling point of 250° C. or lower is used and hence the alkylamine (B) is eliminated from the fine particle surface even upon heating at 150° C. or lower. The manufacturing process of the invention adopts not the reduction of copper(II) in water, which is the case of the process described in Patent Document 1, but the reduction in the solvent (A), so that it is not necessary to take the formed copper hydride from an aqueous phase into an organic phase. Therefore, the elimination ability upon heating at 150° C. or lower can be also secured while the dispersibility of the copper hydride fine particles in the solvent (A) is secured due to the alkylamine (B).

### <Conductive Ink>

The conductive ink of the invention is an ink manufactured using the copper hydride fine particle dispersion obtained by the aforementioned manufacturing process.

As the solvent in the conductive ink of the invention, the solvent (A) may be used or may be replaced with another solvent (hereinafter referred to as “solvent (C)”) other than the solvent (A). Namely, the conductive ink of the invention is obtained by adjusting the solid mass concentration and viscosity of the copper hydride fine particle dispersion obtained by the above manufacturing process or by replacing the solvent (A) with the solvent (C) and adjusting the solid mass concentration and viscosity.

As the solvent (C), it is preferred to use a non-water soluble organic solvent. The term “non-water soluble” means that the amount of dissolution in 100 g of water at room temperature (20° C.) is 0.5 g or less. The solvent (C) is preferably an organic solvent having a small polarity in view of affinity to the alkylamine (B). Also, the solvent (C) is preferably one that does not cause thermal decomposition upon heating at the time of forming the conductor.

Examples of the solvent (C) include decane (insoluble in water), dodecane (insoluble in water), tetradecane (insoluble in water), decene (insoluble in water), dodecene (insoluble in water), tetradecene (insoluble in water), dipentene (amount of dissolution in 100 g of water: 0.001 g (20° C.)), α-terpineol (amount of dissolution in 100 g of water: 0.5 g (20° C.)) and mesitylene (insoluble in water). Of these, from the standpoint of easiness of controlling drying properties of the ink and controlling applicability thereof, α-terpineol, decane, dodecane and tetradecane are preferred.

One kind of the solvent (C) may be used singly or two or more thereof may be used in combination.

As the method of replacing the solvent (A) of the copper hydride fine particle dispersion with the solvent (C), a known solvent replacing method can be adopted and, for example, there may be mentioned a method of adding the solvent (C) while concentrating the solvent (A) under reduced pressure.

The solid mass concentration of the conductive ink (100% by mass) of the invention varies depending on the required viscosity but is preferably from 15 to 70% by mass and more preferably from 20 to 60% by mass. When the solid mass concentration of the conductive ink is the lower limit of the above range or more, a conductor having a sufficient thickness is easily formed. When the solid mass concentration of the conductive ink is the upper limit of the above range or less, it is easy to control ink properties such as viscosity and surface tension and it becomes easy to form the conductor.

The viscosity of the conductive ink of the invention is preferably from 5 to 60 mPa·s and more preferably from 8 to 40 mPa·s. When the viscosity of the conductive ink is the lower limit of the above range or more, the ink can be precisely ejected. When the viscosity of the conductive ink is the upper limit of the above range or less, the ink becomes applicable to almost all available inkjet heads.

The surface tension of the conductive ink of the invention is preferably from 20 to 45 dyn/cm and more preferably from 25 to 40 dyn/cm. When the surface tension of the conductive ink is the lower limit of the above range or more, the ink can be precisely ejected. When the surface tension of the conductive ink is the upper limit of the above range or less, the ink becomes applicable to almost all available inkjet heads.

>Process for Manufacturing Substrate Equipped with Conductor>

The process for manufacturing a substrate equipped with a conductor of the invention is a process of applying the aforementioned conductive ink of the invention on a substrate and heating it to form the conductor.

As the substrate, there may be mentioned glass substrates, plastic substrates (PET substrate, PEN substrate, etc.), fiber-reinforced composite materials (glass fiber-reinforced plastic substrate, etc.), and the like.

As methods of applying the conductive ink, there may be mentioned methods such as inkjet printing, screen printing, a roll coater, an air knife coater, a blade coater, a bar coater, a gravure coater, a die coater, a spray coater, and a slide coater. Of these, the inkjet printing is particularly preferred.

In the case of the inkjet printing, from the standpoint of easiness of formation of a conductor having a desired pattern, it is preferred to control the pore diameter of an ink-ejecting nozzle to from 0.5 to 100 μm and the diameter of the conductive ink at the time of attachment on the substrate to from 1 to 100 μm.

The heating temperature after applying the conductive ink on the substrate is preferably from 60 to 300° C. and more preferably 60 to 150° C.

The heating time may be set to a time for which the conductor can be formed by vaporizing the solvent (C), an acid liberated from the copper(II) salt, the alkylamine (B) eliminated from the fine particle surface, and the like, depending on the heating temperature.

Moreover, from the standpoint of easiness of suppressing the oxidation of the conductor to be formed, heating is preferably performed under an inert atmosphere such as a nitrogen atmosphere.

The thickness of the conductor is preferably from 0.3 to 2.0 μm. In the case where the thickness of the conductor is less than 0.3 μm, there is a concern that the conductor is excessively thin and it becomes difficult to obtain the prescribed conductivity uniformly. Also, in the case where the thickness of the conductor exceeds 2.0 μm, there is a concern that level difference owing to the thickness of wiring becomes a problem on circuit formation.

The volume resistivity of the conductor is preferably from 3 to 35 μΩ·cm. In the case where the volume resistivity of the conductor is less than 3 μΩ·cm, there is no problem as a resistance value of the wiring to be obtained but sintering of the metal particles proceeds to result in a situation where volume contraction is large and cracks occur in the wiring, so that the case is not preferred. On the other hand, in the case where the volume resistivity of the conductor exceeds 35 μΩ·cm, the resistance value of the wiring to be obtained is high and there is a concern that a conductive pattern with a fine wire cannot be formed depending on circuit design, so that the case is not preferred.

According to the process for manufacturing a substrate equipped with a conductor as described above, since a conductor can be formed even upon heating at 150° C. or lower, a substrate equipped with a conductor having a small volume resistivity is obtained even in the case where a substrate having a low heat resistance, such as PET or PEN, is employed.

### EXAMPLES

The following will describe the present invention in detail with reference to Examples but the invention should not be construed as being limited to the following description. Examples 1 to 4 are Working Examples and Examples 5 and 6 are Comparative Examples.

### [Measuring Methods]

### (Identification of Fine Particles}

The identification of fine particles was performed using an X-ray diffraction apparatus (RINT 2500 manufactured by Rigaku Corporation).

### (Average Particle Diameter of Fine Particles)

It was determined by measuring the particle diameter of randomly sampled 100 fine particles using a transmission electron microscope (H-9000 manufactured by Hitachi Ltd.) or a scanning electron microscope (S-800 manufactured by Hitachi Ltd.) and averaging values thereof.

### (Thickness of Conductor)

The thickness of the conductor was measured using a contact-type film-thickness measuring apparatus (DEKTAK 150 manufactured by Veeco).

### (Volume Resistivity of Conductor)

The volume resistivity of the conductor was determined by multiplying a surface resistance value measured using a four probe-type resistance meter (Loresta GP MCP-T610 manufactured by Mitsubishi Petrochemical Co., Ltd.) by the thickness of the conductor.

### Example 1

To a glass vessel were added 300 g of toluene as the solvent (A), 30 g of copper(II) formate tetrahydrate as the copper(II) salt, and 15 g of n-heptylamine (boiling point: 157° C.) as the alkylamine (B), followed by stirring. Then, 4.5 g of NaBH₄ as the hydrido-based reducing agent was added thereto and the whole was stirred, thereby obtaining a black dispersion in which fine particles were dispersed in toluene.

When the fine particles in the dispersion were collected and identified by X-ray diffraction, it was confirmed that the particles were copper hydride fine particles. The average primary particle diameter of the copper hydride fine particles (primary particles) was 10 nm. Moreover, the solid mass concentration of the obtained copper hydride fine particle dispersion was 4% by mass.

The obtained copper hydride fine particle dispersion was concentrated under reduced pressure and α-terpineol was added as the solvent (C) to adjust the viscosity, thereby obtaining a conductive ink. The solid mass concentration of the obtained conductive ink was 30% by mass.

Using the conductive ink, a wiring pattern having a length of 5 cm and a width of 2 mm was printed on a PET film by means of an inkjet printer. The PET film after printing was heated at 150° C. for 1 hour under a nitrogen atmosphere to obtain a PET film equipped with a conductor. The volume resistivity of the formed conductor was 20 μΩ·cm.

### Example 2

Using the conductive ink shown in Example 1, a wiring pattern having a length of 5 cm and a width of 2 mm was printed on a PET film by means of an inkjet printer. The PET film after printing was heated at 120° C. for 1 hour under a nitrogen atmosphere to obtain a PET film equipped with a conductor. The volume resistivity of the formed conductor was 40 μΩ·cm.

### Example 3

A dispersion was obtained in the same manner as in Example 1 except that n-octylamine (boiling point: 176° C.) was used instead of n-heptylamine. When fine particles in the dispersion were collected and identified by X-ray diffraction, it was confirmed that the particles were copper hydride fine particles. The average primary particle diameter of the copper hydride fine particles (primary particles) was 12 nm. Moreover, the solid mass concentration of the obtained copper hydride fine particle dispersion was 2.8% by mass.

Using the obtained copper hydride fine particle dispersion, a conductive ink was obtained in the same manner as in Example 1. The solid mass concentration of the obtained conductive ink was 27% by mass.

Using the conductive ink, a PET film equipped with a conductor was obtained in the same manner as in Example 1. The volume resistivity of the formed conductor was 27 μΩ·cm.

### Example 4

Using the conductive ink shown in Example 1, a wiring pattern having a length of 5 cm and a width of 2 mm was printed on a glass substrate by means of an inkjet printer. The glass substrate after printing was heated at 350° C. for 1 hour under a nitrogen atmosphere to obtain a glass substrate. The volume resistivity of the formed conductor was 8 μΩ·cm.

### Example 5

A dispersion was obtained in the same manner as in Example 1 except that stearylamine (boiling point: 349° C.) was used instead of n-heptylamine. When fine particles in the dispersion were collected and identified by X-ray diffraction, it was confirmed that the particles were copper hydride fine particles. The average primary particle diameter of the copper hydride fine particles (primary particles) was 11 nm. Moreover, the solid mass concentration of the obtained copper hydride fine particle dispersion was 3.1% by mass.

Using the obtained copper hydride fine particle dispersion, a conductive ink was obtained in the same manner as in Example 1. The solid mass concentration of the obtained conductive ink was 30% by mass.

Using the conductive ink, a wiring pattern having a length of 5 cm and a width of 2 mm was printed on a PET film by means of an inkjet printer. The PET film after printing was heated at 150° C. for 1 hour under a nitrogen atmosphere to obtain a PET film equipped with a metal film. However, with regard to the formed metal film, electric conduction was not observed and the volume resistivity was impossible to measure.

### Example 6

A dispersion was obtained in the same manner as in Example 1 except that tetradecylamine (boiling point: 291° C.) was used instead of n-heptylamine. When fine particles in the dispersion were collected and identified by X-ray diffraction, it was confirmed that the particles were copper hydride fine particles. The average primary particle diameter of the copper hydride fine particles (primary particles) was 12 nm. Moreover, the solid mass concentration of the obtained copper hydride fine particle dispersion was 3.2% by mass.

Using the obtained copper hydride fine particle dispersion, a conductive ink was obtained in the same manner as in Example 1. The solid mass concentration of the obtained conductive ink was 29% by mass.

Using the conductive ink, a PET film equipped with a metal film was obtained in the same manner as in Example 5. However, with regard to the formed metal film, electric conduction was not observed and the volume resistivity was impossible to measure.

Table 1 shows measurement results of the volume resistivity in Examples 1 to 6.

TABLE 1

| | Alkylamine (B) | | | | Heating | Volume resistivity |
|---|---|---|---|---|---|---|
| | | Carbon number of | Boiling | | temperature | of conductor |
| | Kind | alkyl group | point | Substrate | [° C.] | [μΩ · cm] |
| Example 1 | n-heptylamine | 7 | 157 | PET | 150 | 20 |
| Example 2 | n-heptylamine | 7 | 157 | PET | 120 | 40 |
| Example 3 | n-octylamine | 8 | 176 | PET | 150 | 27 |
| Example 4 | n-heptylamine | 7 | 157 | Glass | 350 | 8 |
| Example 5 | stearylamine | 18 | 349 | PET | 150 | impossible to measure |
| Example 6 | tetradecylamine | 14 | 291 | PET | 150 | impossible to measure |

As shown in Table 1, in Examples 1 to 3 in which the alkylamine (B) was used, conductors having a small volume resistivity could be formed even upon heating at 150° C. or lower. On the other hand, in Examples 5 and 6 in which an alkylamine having a boiling point exceeding 250° C. was used, the volume resistivity of the formed metal film could not be measured and conductivity was not exhibited. It is considered that this is because the alkylamine on the fine particle surface was not eliminated upon heating at 150° C. and the metal copper fine particles could not be sufficiently combined one another.

Moreover, in Example 4, a conductor was formed using a glass substrate with setting the heating temperature to 350° C. The copper hydride fine particle dispersion of the invention can be applied to substrates other than resin-made substrates and conductors having a better volume resistivity can be also obtained by heating at higher temperature.

While the present invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2010-236497 filed on Oct. 21, 2010, and the contents are incorporated herein by reference.

1. A process for manufacturing a copper hydride fine particle dispersion, the process comprising:
reducing a copper(II) salt with a hydrido-based reducing agent in the following solvent (A) in the presence of the following alkylamine (B):
solvent (A): a solvent having a solubility parameter (SP value) of from 8 to 12 and being inert to the hydrido-based reducing agent and
alkylamine (B): an alkylamine having an alkyl group which has 7 or more carbon atoms and having a boiling point of 250° C. or lower.

2. The process for manufacturing a copper hydride fine particle dispersion according to claim 1, wherein the copper(II) salt is at least one selected from the group consisting of copper(II) acetate, copper(II) formate, copper(II) nitrate, and copper(II) carbonate.

3. The process for manufacturing a copper hydride fine particle dispersion according to claim 1, wherein a molar ratio (Cu/B) of the copper(II) salt to the alkylamine (B) is 1.8 or less.

4. The process for manufacturing a copper hydride fine particle dispersion according to claim 1, wherein the alkylamine (B) is at least one selected from the group consisting of n-heptylamine, n-octylamine, n-nonylamine, 1-aminodecane, and 1-aminoundecane.

5. The process for manufacturing a copper hydride fine particle dispersion according to claim 1, wherein a copper hydride fine particle dispersion containing copper hydride fine particles having an average primary particle diameter of 100 nm or less dispersed therein is obtained.

6. A conductive ink manufactured using the copper hydride fine particle dispersion manufactured by the process for manufacturing a copper hydride fine particle dispersion according to claim 1.

7. A process for manufacturing a substrate equipped with a conductor, the process comprising:
applying the conductive ink according to claim 6 on the substrate, followed by heating the conductive ink to form the conductor.
